(19) United States
(12) Patent Application Publication
(10) Pub. No.: US 2024/0017238 A1
(43) Pub. Date: Jan. 18, 2024

(54) PACKING MEMBER

(71) Applicant: JEMMTEC LIMITED, Dewsbury (GB)

(72) Inventors: Mark STUCKEY, Dewsbury (GB); Richard CAULKIN, Dewsbury (GB)

(21) Appl. No.: 18/265,017

(22) PCT Filed: Dec. 2, 2021
(86) PCT No.: PCT/GB2021/053157

§ 371 Date: Jun. 2, 2023

(30) Foreign Application Priority Data
Dec. 3, 2020 (GB) 2019063.3

(51) Int. Cl. B01J 19/30; B01J 35/08; B01J 37/02; C01B 3/38; C21B 13/00

(52) U.S. Cl. CPC B01J 19/30; B01J 35/08; B01J 37/0201; C01B 3/38; C21B 13/00; C01B 2203/0244; C01B 2203/0261; C01B 2203/1017

(57) ABSTRACT

A packing member for use in a packed bed. The packing member includes ceramic material and surface structures on the outer surface of the packing member. The packing member does not include a fluid communication intra-particle channel extending through the packing member from a first aperture on a first side of the packing member to a second aperture on a substantially opposing second side of the packing member. Also described is a supported catalyst, apparatus and a method of production.

### FIELD

The present invention relates to packing members for packed beds, in particular to supports for catalysts. More specifically, the present invention relates to ceramic catalyst supports and supported catalysts for use in processes such as the steam reforming and the production of direct-reduced iron.

### BACKGROUND

Metal catalysts used in industrial processes such as steam reforming and the production of direct-reduced iron are more active if finely divided into small particles to increase the metal surface area. A large metal surface area can be maintained during such reactions by spreading the metal particles across a refractory support. Another advantage of the use of catalyst supports in such processes is that only a small amount of the more expensive catalytic metals is required for dispersion onto a large amount of abundant inexpensive support materials, thereby considerably reducing the cost of catalytic materials required at commercial scale.

In many such processes the reaction requiring a catalyst is very fast and is limited to the pellet surface. The reaction will therefore depend on the geometric surface area of the supported catalyst. Additionally, a supported catalyst having low internal surface area (BET) and so small internal pore volume will generally suffer from lower activity in such processes. The strength of a support is also important as breakage during the loading, operation and discharge of the supported catalyst can reduce activity and increase delays and costs. For example, in the Midrex process for direct-reduced iron (DRI) the catalysts can be subject to high levels of mechanical handling and thermal cycling, as are steam reforming catalysts. Furthermore, the supported catalyst should provide good heat transfer characteristics while maintaining a low pressure drop.

Supports for catalysts in such industrial processes are typically made by extrusion, pelleting or granulation of ceramic powder followed by calcination of the green body.

However, it has been found that such methods can only offer restricted support geometry and physical properties. For example, such supports may achieve high strength, but only at the expense of low geometric surface area and poor porosity.

Therefore, there is a requirement for improved supports for catalysts having a better combination of desirable properties. Such improved catalysts should also be able to be produced economically. It is therefore an object of aspects of the present invention to address one or more of the abovementioned or other problems.

### SUMMARY

According to a first aspect of the present invention there is provided a packing member for use in a packed bed, wherein the packing member comprises ceramic material and further comprises surface structures on the outer surface of the packing member, and wherein the packing member does not comprise a fluid communication intra-particle channel extending through the packing member from a first aperture on a first side of the packing member to a second aperture on a substantially opposing second side of the packing member.

In the packing member of the present invention, fluid is substantially not able to flow through the packing member in use from a first side of the packing member to a substantially opposite second side of the packing member. Accordingly, to pass the packing member fluid is forced to flow around the outer surface of the packing member. As such, in the context of the present invention, the phrase “does not comprise a fluid communication intra-particle channel extending through the packing member from a first aperture on a first side of the packing member to a second aperture on a substantially opposing second side of the packing member” may be interpreted to mean that substantially no fluid flow is achieved through the body of the packing member in use from a first side of the packing member to a substantially opposite second side of the packing member. It will be understood that such “fluid communication intra-particle channels” in the context of the present invention do not include microscopic porosity that may be present in the material of the packing member.

The packing member may comprise no fluid communication intra-particle channels in the packing member extending from a first aperture to a second aperture.

Advantageously, it has surprisingly been found that the combination of surface structures with the absence of a flow channel through the body of the packing member leads to increased strength while also increasing flow speed, directing flow over the catalyst surface and providing a more uniform flow.

The packing member may be a catalyst support, or a supported catalyst.

The packing member suitably has a macrostructure and surface structures on the outer face of the macrostructure.

The macrostructure may have three major axes wherein all three of the major axes have lengths that are ≤1,000% of the length of each of the other major axes, suitably ≤500% of the length of each of the other major axes, such as 250% of the length of each of the other major axes. The macrostructure may not be in the form of a tape.

The macrostructure may be substantially in the form of a multi-lobe, for example a trilobe, quadralobe or pentalobe; a sphere; an ellipsoid, a cube; a cuboid; a cylinder, or a cog.

The macrostructure may be substantially in the form of a multi-lobe, for example a trilobe, quadralobe or pentalobe; a cube; a cuboid; a cylinder; or a cog.

The packing member may not have a substantially spherical or ellipsoidal macrostructure.

The cog macrostructure comprises a plurality of castellations extending radially outwards. A cog macrostructure may have lateral cross-sections that include substantially circular, triangular, square or rectangular etc when excluding the castellations. At least some, and preferably all, of the castellations may be tapered along the depth and/or the width of the castellation, preferably each castellation is tapered in the same direction as the other castellations of the cog, suitably the widest and deepest points of the castellation are toward the same end of the castellation.

The macrostructure may have a depressed face, such as a depressed upper and/or lower face, suitably at least 30% of the face is depressed, such as at least 40% or at least 50%.

Advantageously, a cog macrostructure having tapered castellations and/or depressed upper or lower face has been found to provide improved packing density in combination with reduced interlocking.

A spherical or ellipsoidal macrostructure may comprise at least one linear groove on the outer face of the macrostructure, such as at least two, at least three or at least four linear grooves. Preferably, a spherical or ellipsoidal macrostructure comprises at least two linear parallel grooves, such as at least three or at least four. Preferably, the grooves are substantially hemispherical in a lateral cross-section. When a spherical or ellipsoidal macrostructure comprises such a linear groove the macrostructure can be considered to be a grooved sphere or ellipsoid.

The macrostructure of the packing member may substantially be in the form of the sphere or an ellipsoid.

The packing member may have a largest dimension of up to 1000 mm, such as up to 750 mm or up to 500 mm, preferably up to 400 mm. The packing member may comprise a width/diameter of up to 500 mm, such as up to 300 mm, or up to 200 mm, preferably up to 150 mm, more preferably up to 100 m, most preferably up to 50 mm.

The packing member may have a largest dimension of >20 mm, such as ≥21 mm or ≥22 mm.

The mean average height of the surface structures of the packing member may be up to 40% of the width/diameter of the packing member, such as up to 30%, preferably up to 25%, more preferably up to 20% and most preferably up to 15%.

By “surface structures” it is meant structures that represent a deviation of the shape of the outer surface of the packing member from the shape that would be expected based on the macrostructure of the packing member. Such surface structures may be significantly smaller than the size of the features of the macrostructure of the packing member. The surface structures may be considered to be surface texturing on the macrostructure of the packing member. It will be understood that such “surface structures” in the context of the present invention do not include microscopic surface roughness.

For example, the packing member may have a spherical macrostructure with a diameter of 10 mm. The outer surface of the said packing member is partially consistently curved as would be expected for a spherical macrostructure, but the outer surface of the packing member also comprises a plurality of surface structures that deviate from the expected curved shape of the outer surface in the form of 12 discrete mounds wherein each mound has a height of 2 mm.

It will be appreciated that normal features of macrostructures such as the castellations of a cog or the lobes of multilobe are considered to be part of the macrostructure and are not considered to be surface structures according to the present invention.

The packing member may comprise surface structures on at least two sides of the packing member.

The packing member may comprise surface structures extending over ≥20% of the outer surface of the packing member, such as over ≥30%, ≥40%, ≥60% or ≥80% of the outer surface.

By “comprise surface structures extending over”, it is meant that at least the specified percentage of the outer surface of the packing member deviates from the expected shape of the outer surface of the packing member based on the macrostructure. It will be appreciated that the amount of the surface that deviates is calculated based on the surface area of the expected shape of the outer surface, and missing portions thereof, rather than on the surface area of the surface structures. For example, the packing member may have a spherical macrostructure with an expected outer surface area of 314 cm², of which 200 cm² deviates from the expected consistent curvature of a spherical macrostructure, and as such the packing member comprises surface structures extending over 63% of the outer surface. For the purposes of this calculation, the expected outer surface area that is occupied by any apertures connecting a fluid communication channel is added to the sum of the remaining expected outer surface area.

The height, suitably the mean average height, of the surface structures of the packing member may be ≤10 mm, preferably ≤7 mm, more preferably ≤6 mm, most preferably ≤5 mm. The height, suitably the mean average height, of the surface structures of the packing member may be ≥0.1 mm, such as ≥0.3 mm, preferably ≥0.5 mm, more preferably ≥0.7 mm, most preferably ≥0.8 mm. The height of the surface structures herein is measured using callipers with a depth measurement function. It will be appreciated that “height” in this context refers to the distance from the lowest point of the surface structure to the highest point of the surface structure.

The packing member may comprise a plurality of repeating surface structures having substantially the same appearance. Preferably, the packing member comprises at least 5 repeating surface structures, more preferably at least 10, such as at least 15, or at least 20, most preferably at least 25.

A surface structure may in the form of a ridge, trough, mound and/or depression.

A surface structure in the form of a ridge or trough is typically elongate and may be in the form of an annular ridge/trough, wherein said annular ridge/trough is not restricted to a circular ring shape. The annular ridge/trough may be in the form of a substantially circular shape or a regular convex polygon, such as a triangle, square, pentagon, hexagon, heptagon, octagon, nonagon, or decagon. Preferably the annular ridge/trough is the form of a regular convex polygon, more preferably pentagon, hexagon or heptagon, most preferably hexagon. The portion of the outer surface that is contained within an annular ridge/trough may be according to the expected shape of the outer surface of the packing member or may be flat, sloped and/or curved. For example, the portion of the outer surface contained within an annular ridge may be in the form of an inverted pyramid. The surface structures may comprise a plurality of connected annular ridge/trough structures, suitably interconnected annular ridge/trough structures such that a ridge of at least a first annular surface structure forms part of a second annular surface structure.

A surface structure in the form of a mound or depression may be a curved, pyramidal and/or stepped mound/depression. A stepped mound/depression may comprise between 2 to 10 steps, such as between 3 and 8 steps. The mound or depression may interconnect such that adjacent mounds/depressions abut or are merged together.

The packing member may have a GSA of ≥0.7 cm²/cm³ and a side crush strength of ≥250 kgf. The packing member may have a geometric surface area per volume (GSA) of ≥0.7 cm²/cm³, such as a GSA of ≥1 cm²/cm³, preferably a GSA of ≥1.2 cm²/cm³, more preferably a GSA of ≥1.3 cm²/cm³, most preferably a GSA of ≥1.4 cm²/cm³. The packing member may have a side crush strength of ≥250 kgf, such as ≥275 kgf, preferably ≥300 kgf, more preferably ≥325 kgf, most preferably ≥350 kgf.

The packing member may have a GSA of ≥1.5 cm²/cm³ and a side crush strength of ≥150 kgf. The packing member may have a GSA of ≥1.7 cm²/cm³, preferably a GSA of ≥1.9 cm²/cm³, more preferably a GSA of ≥2.1 cm²/cm³, most preferably a GSA of ≥2.3 cm²/cm³. The packing member may have a side crush strength of ≥170 kgf, preferably ≥185 kgf, more preferably ≥200 kgf, most preferably ≥215 kgf.

The packing member may have a GSA of ≥3 cm²/cm³ and a side crush strength of ≥60 kgf. The packing member may have a GSA of ≥3.3 cm²/cm³, preferably a GSA of ≥3.6 cm²/cm³, more preferably a GSA of ≥3.9 cm²/cm³, most preferably a GSA of ≥4.2 cm²/cm³. The packing member may have a side crush strength of ≥70 kgf, preferably ≥80 kgf, more preferably ≥90 kgf, most preferably ≥100 kgf.

GSA per volume herein is calculated by measuring the external dimensions of the packing member, including all macrostructure and surface structure features and calculating the surface area. The calculated surface area is then divided by the calculated volume of the packing member. Suitable 3D modelling software can be used to provide these calculations.

Side crush strength herein is represented by a value given in kgf. This is the maximum load recorded at the point of failure of the sample when pressed & crushed between two parallel, flat, hardened steel plates of minimum diameter 80 mm. One plate is fixed to a load cell & recording device, and the other is attached to a ram which moves at a controlled rate of 5 mm/minute. Initial trial tests are carried out to determine the dimension in which the packing member is weakest. The side crush test is then carried out in the weakest direction.

The packing member may have a porosity of ≥0.06 cm³/g, preferably ≥0.15 cm³/g, more preferably ≥20.2 cm³/g, most preferably ≥0.25 cm³/g. Suitably, the packing member has a porosity of ≥0.15 cm³/g, more preferably ≥0.2 cm³/g, most preferably ≥0.25 cm³/g.

The packing member may have a porosity of <0.5 cm³/g, such as ≤0.49 cm³/g or ≤0.48 cm³/g. The packing member may have a porosity of <0.35 cm³/g, such as ≤0.34 cm³/g or ≤0.33 cm³/g.

The packing member may have a porosity of from 0.06 to 0.5 cm³/g, preferably from 0.15 to 0.4 cm³/g, more preferably from 0.2 to 0.35 cm³/g, such as 0.2 to <0.35 cm³/g, most preferably from 0.25 to 0.3 cm³/g, such as 0.25 to <0.3 cm³/g.

Packing member may have a porosity of from 0.15 to 0.5 cm³/g, more preferably from 0.2 to 0.4 cm³/g, most preferably from 0.25 to 0.35 cm³/g, such as 0.25 to <0.35 cm³/g.

Packing member may have a porosity of from >0.35 to <0.5 cm³/g, such as from 0.36 to 0.49 cm³/g.

Porosity herein is measured by mercury intrusion porosimetry, using ASTM D4284-12(2017)e1, Standard Test Method for Determining Pore Volume Distribution of Catalysts and Catalyst Carriers by Mercury Intrusion Porosimetry.

Advantageously, the packing member of the present invention can also provide improved geometric surface area whilst still providing improved strength. Further, the strength and/or porosity of the packing member of the invention may be modified whilst keeping the same shape and thereby reducing redesign requirements and cost. Furthermore, the packing member of the present invention may provide for highly porous supports whilst still providing excellent strength. Most advantageously, the packing member of the present invention may provide improved geometric surface area in combination with excellent strength and high levels of porosity while improving flow velocity and uniformity. The improved geometric surface area of the packing member of the present invention is particularly advantageous for applications in which the catalytic reaction is surface based.

Packing members of the present invention can also provide a high heat transfer co-efficient in combination with other improved properties, such as improved packing.

The packing member of the present invention may also be used to provide excellent packing characteristics with low pressure drop. The packing member of the present invention may provide improved packing density whilst maintaining optimum gas flow.

The packing member of the present invention may be a cast packing member, such as a gel cast packing member. Preferably, the surface structures of the packing member are formed during the moulding step of the packing member, i.e. the step in which the green body of the packing member is formed, suitably by appropriate formations provided in the shape of the mould. As such, preferably the surface structures are not post-fabricated after the moulding of the green body of the packing member.

The packing member may be obtainable by gel casting a composition comprising a ceramic material, an organic binder component and optionally a pore forming component.

The packing member may be formed from a cast moulding composition, preferably a gel cast moulding composition. The packing member may be formed from a moulding composition comprising an organic binder component, a ceramic material, and optionally a pore forming component.

The organic binder component may be operable to be substantially removed from the packing member after moulding of the packing member, preferably with heat treatment, more preferably removed during calcination of the packing member.

The organic binder component may comprise a polymerisable component, suitably including a polymerisable monomer and a crosslinking member, wherein the binder component is operable to polymerise to from a (co)polymer.

The polymerisable monomer may comprise one or more type of ethylenically unsaturated monomers, such as an acrylic monomer or derivative thereof such as an acrylamide monomer, and/or a vinyl monomer, such as a monomer selected from one or more of methacrylamide (MAM), N-(hydroxymethyl)acrylamide (hMAM), hydroxyethyl acrylamide (hEAM) and/or N-vinyl-2-pyrrolidinone (NVP). Preferably, the polymerisable monomer comprises one or more acrylamide monomers, more preferably a monomer selected from one or more of methacrylamide (MAM), N-(hydroxymethyl)acrylamide (hMAM) and hydroxyethyl acrylamide (hEAM). Most preferably, the polymerisable monomer comprises MAM.

The crosslinking member may be selected from one or more of a diethylenically unsaturated monomer, such as a diacrylic monomer or derivative thereof such as a diacrylamide monomer; an acrylic salt and/or a polyethylene glycol substituted acrylic monomer. The crosslinking member may be selected from one or more of poly(ethylene glycol) dimethacrylate (PEGDMA), N,N′-methylenebis(acrylamide) (BIS), ammonium acrylate and PEG methylethylmethacrylate (PEGMEM), preferably one more of poly(ethylene glycol) dimethacrylate (PEGDMA), and N,N′-methylenebis(acrylamide) (BIS).

The organic binder component may be formed from 40 to 9 wt % of polymerisable monomer and from 60 to 5 wt % of crosslinking member, such as from 50 to 90 wt % of polymerisable monomer and from 50 to 10 wt % of crosslinking member, or from 55 to 85 wt % of polymerisable monomer and from 45 to 15 wt % of crosslinking member, or from 60 to 80 wt % of polymerisable monomer and from 40 to 20 wt % of crosslinking member, such as from 65 to 75 wt % of polymerisable monomer and from 35 to 25 wt % of crosslinking member.

The composition may further comprise a polymerisation accelerator, operable to accelerate the polymerisation of the binder component. The polymerisation accelerator may be any suitable accelerator. For example, the accelerator may be tetramethylethylenediamine (TEMED).

The composition may further comprise an initiator operable to initiate polymerisation of the binder component. The initiator may be any suitable initiator. The initiator may be a free radical initiator. For example, the initiator may be ammonium persulphate and/or potassium persulphate.

The pore forming material may be operable to be removed from the packing member after moulding of the packing member, preferably with heat treatment, more preferably during calcination of the packing member. The pore forming material may be selected from one or more of microbeads, starch, seeds and/or cellulose.

The pore forming material may have a particle size distribution wherein D₁₀ is from 5 to 100 μm, preferably from 10 to 75 μm, more preferably from 15 to 50 μm, most preferably from 20 to 40 μm. The D₅₀ of the pore forming material may be from 50 to 200 μm, preferably from 75 to 175 μm, more preferably from 90 to 160 μm, most preferably from 100 to 150 μm. The Do of the pore forming material may be from 120 to 300 μm, preferably from 150 to 270 μm, more preferably from 170 to 250 μm, most preferably from 185 to 235 μm.

The ceramic material may be a refractory ceramic material. The ceramic material may comprise aluminium oxide, aluminium silicate, magnesium aluminate, calcium aluminate, zirconia, silica, titanate, carbon and/or magnesium oxide, or precursors thereof.

The ceramic material may have a particle size distribution wherein D₁₀ is from 0.1 to 20 μm, preferably from 0.5 to 10 μm, more preferably from 1 to 5 μm, most preferably from 1.5 to 3 μm. The D₅₀ of the pore forming material may be from 0.5 to 30 μm, preferably from 1 to 25 μm, more preferably from 1.5 to 20 μm, most preferably from 2 to 15 μm. The D₉₀ of the pore forming material may be from 10 to 100 μm, preferably from 15 to 80 μm, more preferably from 20 to 70 μm, most preferably from 25 to 60 μm.

The ceramic material may be a ceramic powder. The ceramic powder may be ball milled or spray dried. Advantageously, it has been found that ball milled or spray dried ceramic powder provides easier casting behaviour.

The composition or packing member may comprise a promoter, operable to increase the reactivity of the main reaction, and/or decrease undesirable side reactions.

The promoter may be selected from one or more of oxides of lanthanum, copper, magnesium, manganese, potassium, calcium, zirconium, barium, cerium, sodium, lithium, molybdenum, yttrium, cobalt, and chromium.

The composition may further comprise a carrier, such as aqueous carrier. Suitably the composition is an aqueous ceramic slurry.

The composition may comprise further additives. For example, the composition may comprise a dispersant, such as a polymeric salt, for example a salt of a polyacrylic, preferably an ammonium salt of a polyacrylic. A suitable dispersant may be selected from one or more of Ecodis P90, Narlex LD42 and Dispex A40.

The composition may comprise from 0.1 to 10% of polymerisable monomer by dry weight of the composition, preferably from 0.5 to 8 wt %, more preferably from 1 to 6 wt %, such as from 1.5 to 5 wt %, most preferably from 2 to 4 wt %.

The composition may comprise from 0.1 to 10% of crosslinking member by dry weight of the composition, preferably from 0.5 to 8 wt %, more preferably from 0.75 to 6 wt %, such as from 1 to 5 wt %, most preferably from 1 to 4 wt %.

The composition may comprise from 50 to 95% of ceramic material by dry weight of the composition, preferably from 50 to 90 wt %, more preferably from 55 to 85 wt %, most preferably from 60 to 80 wt %. The packing member may comprise at least 75% of ceramic material by dry weight of the composition, preferably at least 85 wt %, more preferably at least 90 wt %, such as at least 95 wt %, most preferably at least 97 wt % ceramic material.

The composition may comprise from >0 to 40% of pore forming member by dry weight of the composition, preferably from 0.5 to 30 wt %, more preferably 2 to 25 wt %, such as from 3 to 20 wt %, most preferably from 4 to 15 wt %.

The composition may comprise from 0.1 to 5% of initiator by dry weight of the composition, preferably from 0.5 to 4 wt %, more preferably from 0.75 to 3.5 wt %, most preferably from 1 to 3 wt %.

The composition may comprise up to 5% of accelerator by dry weight of the composition, preferably up to 3 wt %, more preferably up to 2 wt %, most preferably up to 1.5 wt %.

The composition may comprise from 0.1 to 10% of dispersant by dry weight of the composition, preferably from 0.5 to 8 wt %, more preferably 0.75 to 6 wt %, most preferably from 1 to 5 wt %.

The composition may have a solids content of from 45 to 99% by total weight of the composition, such as from 50 to 95 wt %, preferably from 55 to 90 wt %, most preferably from 60 to 85 wt %.

The composition may be formed by combining a pre-formed aqueous binder component with a ceramic composition. Suitably the aqueous binder component comprises a polymerisable monomer, a crosslinking member and water.

The packing member may be substantially free of catalytic material. The packing member of the present invention may be an inert packing member that is substantially free of catalytic material. Advantageously, the use of inert packing member according to the present invention in a catalyst bed provides improved heat transfer and gas flow turbulence which helps the reactive media further along the reactor to be at a suitable temperature for the desired reaction.

The packing member of the present invention may be a supported catalyst, which further comprises catalytic material. The catalytic material is suitably operable to provide catalytic activity in desired process to which the supported catalyst is applied.

The catalytic material may comprise a metal selected from one or more of a transition metal, suitably a transition metal oxide, and/or a noble metal, suitably an alloy thereof. The catalytic material may comprise a metal selected from one or more of iron, nickel, silver, gold, platinum, ruthenium, vanadium, molybdenum, and cobalt.

According to a second aspect of the present invention there is provided a method for producing a packing member, suitably a packing member according to the first aspect of the present invention, comprising the steps of:
a. contacting a composition for producing a packing member, suitably a gel cast composition as defined in relation to the first aspect, with an initiator and optionally a polymerisation accelerator;
b. arranging the resulting composition of step (a) in a mould;
c. demoulding the composition to produce a green body,
d. optionally, drying the green body at room temperature or baking the green body at elevated temperature;
e. calcining the green body;
f. optionally, contacting the packing member with a catalytic material.

The composition may be mixed before arranging in the mould to form a homogeneous slurry, suitably before addition of initiator and the optional accelerator.

The composition may be mixed after addition of the initiator and the optional accelerator to form a homogeneous slurry.

The mould is preferably a cast mould. The mould may be operable to form surface structures on the green body.

The green body produced by step (c) may be dried by baking the green body at ≥40° C., such as ≥50° C. or ≥55° C. or ≥60° C. Suitably, the green body may be baked for ≥10 hours, such as ≥15 hours or ≥20 hours, for example ≥24 hours.

The green body may be calcined at ≥1000° C., preferably ≥1200° C., more preferably ≥1400° C., most preferably ≥1500° C. Suitably, the green body is fired until substantially all of the binder and pore forming component has been removed from the packing member or supported catalyst.

The packing member may be contacted, suitably impregnated, with catalytic material by dipping the packing member into a solution of the catalytic material. The dipped packing member may be dried after dipping.

Advantageously, the present invention enables the green packing member or supported catalyst body to be removed from the mould while it is in a form that is still relatively rubbery, allowing for easier handling. This leads to a lower scrap rate than other types of casting techniques.

The supported catalyst may be for use in a packed-bed reactor for the production of synthesis gas, such as ammonia, methanol, hydrogen, hydrogen peroxide and/or oxoalcohols; direct reduction of iron (DRI); endothermic gas generation; catalytic partial oxidation; autothermal reforming or production of an alkylene oxide, such as ethylene oxide, 1,9-decadiene oxide, 1,3-butadiene oxide, 2-butene oxide, isobutylene oxide, 1-butene oxide and/or propylene oxide.

The supported catalyst may be for use in a packed-bed reactor for the production of synthesis gas, such as ammonia, methanol, hydrogen, hydrogen peroxide and/or oxoalcohols; direct reduction of iron (DRI); endothermic gas generation; catalytic partial oxidation; or autothermal reforming.

The supported catalyst may not be for use in a packed-bed reactor for the production of an alkylene oxide.

According to a third aspect of the present invention there is provided a method for producing a packing member, suitably a packing member according to the first aspect of the present invention, the method comprising the steps of:
a. optionally, producing a digital model of a packing member;
b. producing a precursor according to the model using additive manufacturing, preferably printing with a 3D printer;
c. forming a cast mould from the precursor;
d. cast moulding a moulding composition, suitably a moulding composition as defined in relation to the first aspect, to form a packing member; suitably according to the method of the second aspect of the present invention.

According to a fourth aspect of the present invention there is provided a reactor comprising a catalyst bed wherein the catalyst bed comprises a packing member according to the first aspect of the present invention.

According to a fifth aspect of the present invention there is provided a reaction medium comprising a catalyst bed wherein the catalyst bed comprises a packing member according to the first aspect of the present invention.

Suitably, the reactor or reaction medium is for the production of synthesis gas, such as ammonia, methanol, hydrogen, hydrogen peroxide and/or oxoaicohols; direct reduction of iron (DRI); endothermic gas generation; catalytic partial oxidation; autothermal reforming or production of an alkylene oxide such as ethylene oxide, 1,9-decadiene oxide, 1,3-butadiene oxide, 2-butene oxide, isobutylene oxide, 1-butene oxide and/or propylene oxide.

Suitably, the reactor or reaction medium is for the production of synthesis gas, such as ammonia, methanol, hydrogen, hydrogen peroxide and/or oxoalcohols; direct reduction of iron (DRI); endothermic gas generation; catalytic partial oxidation; or autothermal reforming.

According to a sixth aspect of the present invention there is provided the use of a packing member according to the first aspect of the present invention as a catalyst support.

According to a seventh aspect of the present invention there is provided the use of a packing member according to the first aspect of the present invention as an absorber, for examples as a contaminant remover.

According to an eighth aspect of the present invention there is provided a method of treating a mixture, such as a fluid mixture, to selectively remove a target component of the mixture, such as a contaminant, comprising:
a. contacting said fluid with a packing member according to the first aspect of the present invention to transfer at least a portion of the target component to the packing member.

According to a ninth aspect of the present invention, there is provided a method for the production of a synthesis gas, such as ammonia, methanol, hydrogen, hydrogen peroxide and/or oxoalcohols comprising the use of a reactor comprising a catalyst bed wherein the catalyst bed comprises a packing member according to the first aspect of the present invention to produce the synthesis gas.

According to a tenth aspect of the present invention, there is provided a method for the production of direct reduced iron comprising the use of a reactor comprising a catalyst bed wherein the catalyst bed comprises a packing member according to the first aspect of the present invention to produce the direct reduced of iron.

According to an eleventh aspect of the present invention, there is provided a method for endothermic gas generation comprising the use of a reactor comprising a catalyst bed wherein the catalyst bed comprises a packing member according to the first aspect of the present invention for the endothermic gas generation.

According to a twelfth aspect of the present invention, there is provided a method for catalytic partial oxidation comprising the use of a reactor comprising a catalyst bed wherein the catalyst bed comprises a packing member according to the first aspect of the present invention for the catalytic partial oxidation.

According to a thirteenth aspect of the present invention, there is provided a method for autothermal reforming comprising the use of a reactor comprising a catalyst bed wherein the catalyst bed comprises a packing member according to the first aspect of the present invention for the autothermal reforming.

According to a fourteenth aspect of the present invention, there is provided a method for the production of ethylene oxide comprising the use of a reactor comprising a catalyst bed wherein the catalyst bed comprises a packing member according to the first aspect of the present invention to produce an alkylene oxide such as such as ethylene oxide, 1,9-decadiene oxide, 1,3-butadiene oxide, 2-butene oxide, isobutylene oxide, 1-butene oxide and/or propylene oxide, suitably for ethylene oxide.

As used herein, unless otherwise expressly specified, all numbers such as those expressing values, ranges, amounts or percentages may be read as if prefaced by the word “about”, even if the term does not expressly appear. The term “about” when used herein means +/−10% of the stated value. Also, the recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Also, any numerical range recited herein is intended to include all sub-ranges subsumed therein.

Singular encompasses plural and vice versa. For example, although reference is made herein to “an” organic binder component, “a” ceramic material, “a” pore forming component, and the like, one or more of each of these and any other components can be used. As used herein, the term “polymer” refers to oligomers and both homopolymers and copolymers, and the prefix “poly” refers to two or more. Including, for example and like terms means including for example but not limited to. The terms “comprising”, “comprises” and “comprised of” as used herein are synonymous with “including”, “includes” or “containing”, “contains”, and are inclusive or open-ended and do not exclude additional, non-recited members, elements or method steps. Additionally, although the present invention has been described in terms of “comprising”, the processes, materials, and coating compositions detailed herein may also be described as “consisting essentially of” or “consisting of”.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

Where ranges are provided in relation to a genus, each range may also apply additionally and independently to any one or more of the listed species of that genus. For example, the composition may comprise from 0.1 to 10% of polymerisable monomer, by total dry weight of the composition, which polymerisable monomer comprises methacrylamide in an amount such that the composition comprises from 0.1 to 10% of methacrylamide, by total dry weight of the composition. Similarly, the composition may comprise from 0.1 to 10% of polymerisable monomer, by total dry weight of the composition, which polymerisable monomer comprises methacrylamide and hydroxyethyl acrylamide in an amount such that the composition comprises from 0.1 to 10% of methacrylamide and hydroxyethyl acrylamide, by total dry weight of the composition. A further example may be wherein the composition comprises from 0.1 to 10% of polymerisable monomer, by total dry weight of the composition, which polymerisable monomer comprises methacrylamide and hydroxyethyl acrylamide in an amount such that the composition comprises 20.1% of methacrylamide, by total dry weight of the composition. Further, for example, the invention may comprise from 0.1 to 10% of polymerisable monomer, by total solid weight of the composition, which polymerisable monomer comprises methacrylamide and hydroxyethyl acrylamide in an amount such that the composition comprises ≤6% of methacrylamide, by total solid weight of the composition. Further examples of the abovementioned include the ranges provided for the organic binder, the crosslinking member, the ceramic material, the pore forming member, the initiator, the accelerator, and the dispersant, and all associated species, sub-genera and sub species.

All of the features contained herein may be combined with any of the above aspects in any combination.

For a better understanding of the invention, and to show how embodiments of the same may be carried into effect, reference will now be made, by way of example, to the following experimental data and figures.

### BRIEF DESCRIPTION OF DRAWINGS

FIG. 1 shows a perspective view of a first comparative packing member.

FIG. 2 shows a perspective view of a second comparative packing member.

FIG. 3 shows a perspective view of a packing member according to the present invention.

FIG. 4 shows a cross-section from the side of the column of the flow results for the first comparative packing member.

FIG. 5 shows a cross-section from the side of the column of the flow results for the second comparative packing member.

FIG. 6 shows a cross-section from the side of the column of the flow results for the packing member according to the present invention.

FIG. 7 shows a cross-section from the top of the column of the flow results for the first comparative packing member.

FIG. 8 shows a cross-section from the top of the column of the flow results for the second comparative packing member.

FIG. 9 shows a cross-section from the top of the column of the flow results for the packing member according to the present invention.

### DESCRIPTION OF EMBODIMENTS

Computational fluid dynamics (CFD) compared the performance of two comparative packing members to a packing member according to the present invention.

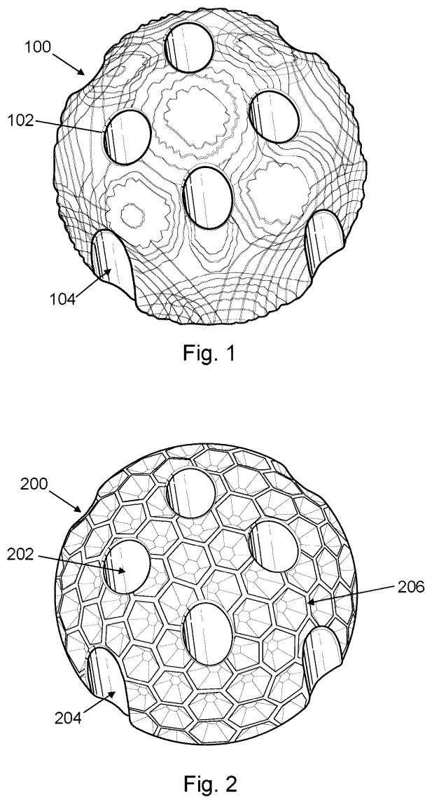

The first comparative packing member 100, shown in FIG. 1, has a 16 mm diameter grooved spherical macrostructure with four equally spaced parallel fluid communication intra-particle channels in the form of bores 102 extending between apertures on opposite sides of the outer surface of the packing member. The grooves 104 of packing member 100 are in the form of four equally spaced parallel linear grooves with curved lateral cross-sections on the outer surface of the packing member. The outer surface of the packing member 100 has the expected smooth continuous curvature of a spherical macrostructure.

The second comparative packing member 200, shown in FIG. 2, is the same as the first comparative packing member, with bores 202 and grooves 204, but in addition the outer surface of packing member 200 comprises surface structures in the form of a plurality of interconnected hexagon-shaped annular ridged surface structures 206 extending over substantially the whole of the outer surface apart from the apertures of bores 202 and the surface of grooves 204. The portion of the outer surface that extends between the inner edges of the annular ridges is formed of an open ended inverted hexagonal pyramid.

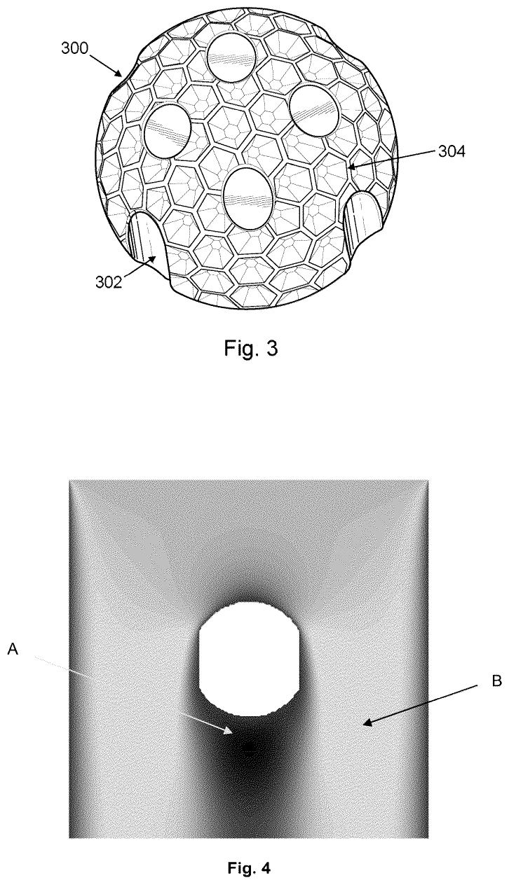

The packing member according to the present invention 300, shown in FIG. 3, is the same as the second comparative packing member, with grooves 302 and surface structures 304, except that packing member 300 does not have fluid communication intra-particle channels extending through the body of the packing member.

CFD was used to test the flow around the above-mentioned packing members.

The test conditions were as follows:
Large tube diameter selected so as to not interfere with flow around pellet (50 mm ID)
Simulation resolution 0.125 mm per pixel
Flow rate: 0.4 m³/min
Orientation of the holes/side-channels in the same direction of flow

The result of the flow tests were:

Measured stagnant velocity zone below pellet (truncated cone)

| | Comp. | Comp. | Inv. |
|---|---|---|---|
| | packing | packing | packing |
| | member 1 | member 2 | member |
| Height of dead | 7.5 mm | 7.4 mm | 7.25 mm |
| zone below pellet | | | |
| Domain avg | 0.05082 | 0.05088 | 0.05095 |
| velocity | | | |
| Re | 1414.8 | 1416.5 | 1330.3 |

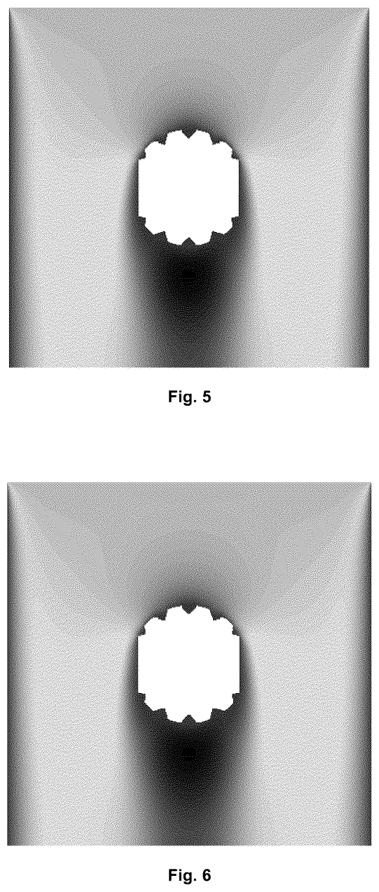

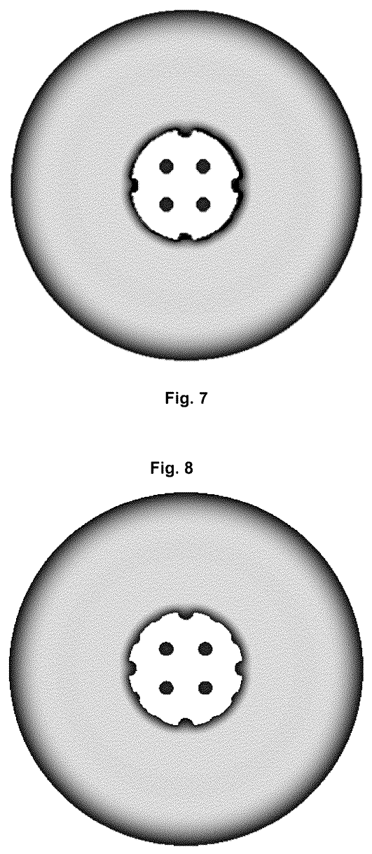

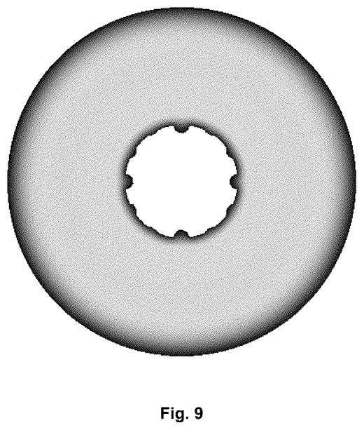

As shown by the results of the above table and in FIGS. 4 to 9, compared to the first comparative packing member, the packing member according to the invention provides a higher gas velocity in contact with the packing member. In FIGS. 4 to 9, darker areas such as “A” in FIG. 5 indicate a lower/static gas velocity and lighter areas such as “B” in FIG. 5 indicate a higher gas velocity. In addition, the packing member according to the invention provides a higher amount of gas turbulence above the packing member, and also provides a smaller velocity static zone below the packing member.

Compared to the second comparative packing member, the packing member according to the invention surprisingly results in minimal difference in velocity patterns despite the absence of intra-particle flow channels. Advantageously, the packing member according to the invention further surprisingly has a higher velocity with a lower Re number than the second comparative packing member, signifying lower turbulence and improved uniformity of flow.

Furthermore, the packing member according to the present invention was found to have significantly higher side crush strength than the first or second comparative packing members.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A packing member for use in a packed bed, wherein the packing member comprises ceramic material and further comprises surface structures on the outer surface of the packing member, and wherein the packing member does not comprise a fluid communication intra-particle channel extending through the packing member from a first aperture on a first side of the packing member to a second aperture on a substantially opposing second side of the packing member.

2. A packing member according to claim 1, wherein the packing member has a macrostructure that is substantially in the form of a multi-lobe, for example a trilobe, quadralobe or pentalobe; a sphere; an ellipsoid, a cube; a cuboid; a cylinder, or a cog.

3. (canceled)

4. (canceled)

5. The packing member according to claim 1, wherein the packing member comprises a plurality of repeating surface structures having substantially the same appearance, and/or wherein the packing member comprises surface structures extending over ≥20% of the outer surface of the packing member.

6. The packing member according to claim 1, wherein the packing member comprises surface structures extending over ≥60% of the outer surfacer.

7. (canceled)

8. (canceled)

9. The packing member according to claim 1, wherein the packing member has a geometric surface area per volume (GSA) of ≥0.7 cm²/cm³.

10. The packing member according to claim 1, wherein the packing member has a side crush strength of ≥250 kgf.

11. The packing member according to claim 1, wherein the packing member has a GSA of ≥1.7 cm²/cm³.

12. The packing member according to claim 1, wherein the packing member has a side crush strength of ≥70 kgf.

13. The packing member according to claim 1, wherein the packing member has a GSA of ≥3.3 cm²/cm³.

14. The packing member according to claim 1, wherein the packing member has a side crush strength of ≥70 kgf.

15. The packing member according to claim 1, wherein the packing member has a porosity of ≥0.06 cm³/g.

16. The packing member according to claim 1, wherein the packing member has a porosity of <0.5 cm³/g.

17. (canceled)

18. (canceled)

19. The packing member according to claim 1, wherein the packing member is a cast packing member and/or wherein the packing member is obtainable by gel casting a composition comprising a ceramic material, an organic binder component and optionally a pore forming component.

20. (canceled)

21. The packing member according to claim 19, wherein the organic binder component is formed from 40 to 95 wt % of polymerisable monomer and from 60 to 5 wt % of crosslinking member; and/or wherein the ceramic material comprises aluminium oxide, aluminium silicate, magnesium aluminate, calcium aluminate, zirconia, silica, titanate, carbon and/or magnesium oxide, or precursors thereof; and/or wherein the composition or packing member comprises a promoter; and/or wherein the composition comprises from 0.1 to 10% of polymerisable monomer by dry weight of the composition; and/or wherein the composition comprises from 50 to 95% of ceramic material by dry weight of the composition.

22. A supported catalyst comprising a packing member according to claim 1 and further comprising catalytic material.

23. (canceled)

24. (canceled)

25. (canceled)

26. A method for producing a packing member/supported catalyst according to claim 1, comprising the steps of:
a. contacting a composition for producing a packing member with an initiator and optionally a polymerisation accelerator;
b. arranging the resulting composition of step (a) in a mould;
c. demoulding the composition to produce a green body,
d. optionally, drying the green body at room temperature or baking the green body at elevated temperature;
e. calcining the green body;
f. optionally, contacting the packing member with a catalytic material.

27. A reactor comprising a catalyst bed wherein the catalyst bed comprises a packing member and/or supported catalyst according to claim 1.

28. A reaction medium comprising a catalyst bed wherein the catalyst bed comprises a packing member and/or supported catalyst according to claim 1.

29. (canceled)

30. A method of treating a mixture to selectively remove a target component of the mixture, comprising:
a. contacting said fluid with a packing member and/or supported catalyst according to claim 1 to transfer at least a portion of the target component to the packing member/supported catalyst.

31. A method for
i. the production of a synthesis gas, comprising the use of a reactor comprising a catalyst bed wherein the catalyst bed comprises a packing member and/or supported catalyst according to claim 1 to produce the synthesis gas;
ii. the production of direct reduced iron comprising the use of a reactor comprising a catalyst bed wherein the catalyst bed comprises a packing member and/or supported catalyst according to claim 1 to produce the direct reduced iron;
iii. endothermic gas generation comprising the use of a reactor comprising a catalyst bed wherein the catalyst bed comprises a packing member and/or supported catalyst according to claim 1 for the endothermic gas generation,
iv. catalytic partial oxidation comprising the use of a reactor comprising a catalyst bed wherein the catalyst bed comprises a packing member and/or supported catalyst according to claim 1 for the catalytic partial oxidation; or
v. autothermal reforming comprising the use of a reactor comprising a catalyst bed wherein the catalyst bed comprises a packing member and/or supported catalyst according to claim 1 for the autothermal reforming.
